(19) United States
(12) Patent Application Publication
(10) Pub. No.: US 2004/0204002 A1
(43) Pub. Date: Oct. 14, 2004

(54) Communication device for automatically obtaining recipient's local time and method thereof

(76) Inventors: Yu-Bin Chen, Shanghau City (CN); Shih-Kuang Tsai, Hsinchu-City (TW)

Correspondence Address: BIRCH STEWART KOLASCH & BIRCH, PO BOX 747, FALLS CHURCH, VA, 22040-0747, US

(21) Appl. No.: 10/206,365

(22) Filed: Jul. 29, 2002

(51) Int. Cl. H04M 1/00

(52) U.S. Cl. 455/550.1; 455/566

(57) ABSTRACT

A communication device. The device includes a memory storing original time difference data and a time difference database having a reserve of communication data and localized time difference data respectively corresponding to the communication data. The communication device is characterized in that when the communication device executes communication according to a communication code with the communication data, the communication device retrieves localized time difference information corresponding to the communication data from the time difference database and obtains the recipient's local time data according to the original time difference data and the corresponding localized time difference data.

### BACKGROUND OF THE INVENTION

1. Field of the Invention

The present invention relates to a communication device for automatically obtaining recipient's local time, and particularly to a portable communication device programmable to display recipient's local time thereon, such as a cellular phone, a screen phone, or a PDA.

2. Description of the Related Art

Wireless communication is widely used all over the world, and is integrated into international communication systems. For example, a user can execute international communications with a wireless communication device, such as a cellular phone. Meanwhile, the size and weight of the wireless communication device has been reduced for convenience.

Conventionally, a portable communication device, such as the above-mentioned cellular phone, provides time data. Users normally set the time data of the cellular phone to conform to the time zone of the user's location. However, if the user places a call with the conventional cellular phone to a recipient in another country or region in a different time zone, the user cannot receive any information regarding the recipient's local time from the cellular phone. In this case, the user either needs to look up the time difference between the user's location and the recipient's location from a time zone table or memorize the time difference in order to obtain local time data according to the time difference and the time data. Otherwise, if the user blindly makes the phone call without knowing the local time, there is a chance that the call may be placed at an inappropriate time. This leads to inconvenience for both the user and the recipient.

Consequently, it is much more convenient for both the user and the recipient if the user obtains the recipient's local time data without memorizing or looking up for the time difference. That is, if the user recieves the recipient's local time data directly from the communication device, such as the cellular phone, when making the phone call, the user can place the call at an appropriate time.

### SUMMARY OF THE INVENTION

In view of this, the present invention discloses a communication device that automatically obtains and displays a recipient's local time on the communication object, so that the user does not need to externally check the recipient's local time.

The present invention discloses a communication device. The communication device includes a memory that stores original time difference data and a time difference database having a reserve of communication data and localized time difference data respectively corresponding to the communication data. The communication device is characterized in that when the communication device performs communication according to a code in accordance with the communication data, the communication device retrieves localized time difference information corresponding to the communication data from the time difference database and obtains a recipient's local time data according to the original time difference data and the corresponding localized time difference data.

Further, the above-mentioned communication device may preferably have a module for amending the communication data and the localized time difference of the time difference database.

The present invention also discloses a method for obtaining recipient's local time with a communication device, as described above. The method comprises the steps of: executing communication according to a communication code with the communication data; retrieving localized time difference information corresponding to the communication data from the time difference database; and obtaining a recipient's local time data according to the original time difference data and the corresponding localized time difference data.

In the present invention, the communication code may include telephone number data, and each of the communication data may include a country code and area code. Further, the communication device can be a cellular phone, a screen phone, or a personal digital assistant (PDA).

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view showing an embodiment of the communication device of the present invention; and

FIG. 2 is a flowchart showing the method of obtaining recipient's local time of the present invention.

### DETAILED DESCRIPTION OF THE INVENTION

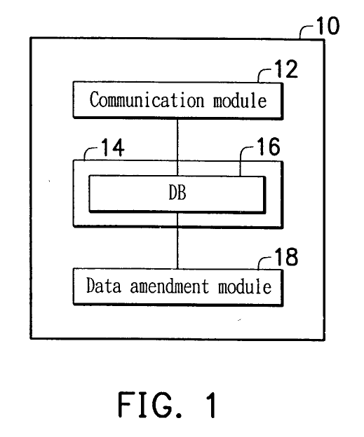

An embodiment of the communication device of the present invention can be described with reference to FIG. 1. The communication device of the present invention can be a cellular phone 10, as shown in FIG. 1, or any other communication device, such as a screen phone or a personal digital assistant (PDA).

The cellular phone 10 has a communication module 12 and a memory 14. The communication module 12 executes communication, i.e. a dialer. The memory 14 can be a commercially available SIM card, in which original time difference data and a time difference database 16 is stored.

The original time difference data refers to a standard time difference, such as Greenwich Mean Time (GMT), which corresponds to the location of the system of the cellular phone 10. For example, the standard time zone data for Taiwan/Hong Kong is GMT+8, while the standard time zone data for France is +1. Thus, the cellular phone 10 can obtain and display the corresponding time data for the location, based on the original time difference.

The time difference database 16 has a reserve of communication data and localized time difference data respectively corresponding to the communication data. The communication data refers to a localized code that indicates a specific location, such as a country code and area code. For example, France has a country code of 33, and Paris has an area code of 1, so the communication data for Paris, France can be “331”. Further, the localized time difference in France is “+1,” so the communication data “331” and the localized time difference “+1” can be stored in the time difference database 16 in a set that indicates Paris. Thus, various sets of communication data and localized time difference data can be stored in the time difference database 16.

Further, the cellular phone 10 in this embodiment has a data amendment module 18 for amending the communication data (i.e. the country code and the area code) and the localized time difference of the time difference database 16.

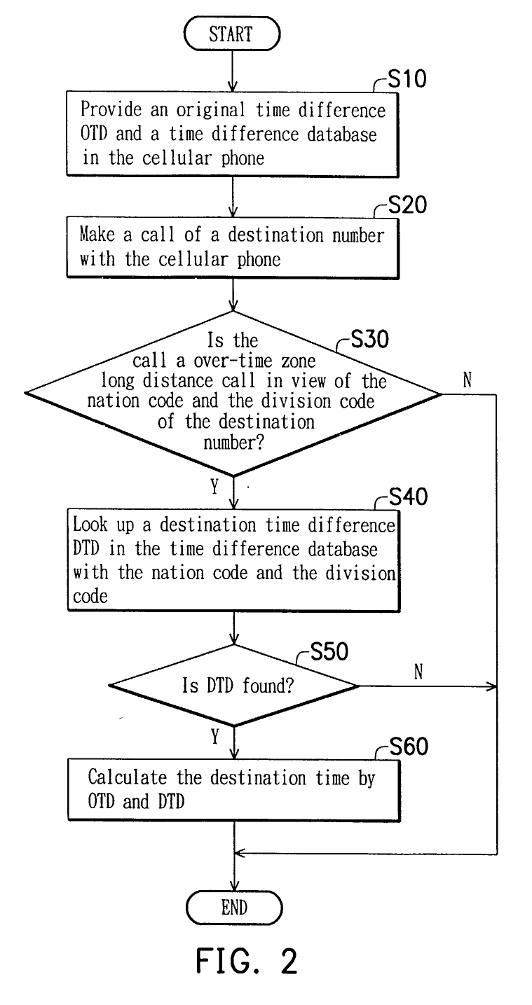

Further, the method of obtaining recipient's local time with the above-mentioned cellular phone 10 is described with reference to FIG. 2. In the cellular phone 10, the memory 14 that stores original time difference data OTD and a time difference database 16 is provided (step S10). For example, if a user in Taiwan has the original time difference data in his/her cellular phone 10 preset at “+8”, when the user makes a phone call to a destination number (a communication code, i.e. the telephone number of the recipient) with the cellular phone 10 (step S20), the cellular phone 10 references part of the destination number that identifies the communication data (i.e. the country code and the area code of the telephone number) of the communication code, determining if the phone call is an inter-zone call (an international phone call) in view of the country code and the area code (step S30). If the phone call is an intra-zone call (within the user's own time zone), the recipient's local time is not necessary to the user.

However, if the phone call is exactly an international phone call, such as a destination number “+33-1-23456789” dialed from Taiwan, the cellular phone 10 identifies the country code “33” and the area code “1” of the destination number and determines the destination object is Paris, France. In this case, the cellular phone 10 looks for a recipient's local time difference data DTD in the localized time difference stored in the time difference database 16 with the communication data “331” (step S40), the combination of the country code “33” and the area code “1.” Since the destination number is an actual number, the recipient's local time difference data DTD of Paris can be found (step S50) to correspond to the localized time difference “+1” stored in the time difference database 16, so that the cellular phone 10 may obtain and display the recipient's local time data (step S60) according to the original time difference data OTD (i.e. “+8” in Taiwan) and the corresponding localized time difference data (i.e. “+1” in Paris). That is, the recipient's local time in Paris is seven hours before the time in Taiwan.

In this case, the user in Taiwan receives the recipient's local time data in Paris directly from the cellular phone 10. Thus, the user does not need to externally access the recipient's local time data by memory or with a time zone table.

It should be noted that the communication device of the above-mentioned embodiment is a cellular phone 10. However, the communication device applied in the present invention can be any other portable communication device, such as a screen phone or a PDA.

Further, the communication data of the above-mentioned embodiment includes a country code and area code. However, the communication data of the present invention is not limited to specific types of data in the communication code. That is, the communication data may be an encrypted code or any other data other than the country code and the area code, and the localized time difference stored in the time difference database 16 is then modified or rearranged according to the communication data.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A communication device comprising a memory, wherein the memory stores:
original time difference data; and
a time difference database having a reserve of communication data and localized time difference data respectively corresponding thereto;
the communication device being characterized that:
when the communication device executes communication according to a communication code with the communication data, the communication device retrieves localized time difference information corresponding to the communication data from the time difference database and obtains a recipient's local time data according to the original time difference data and the corresponding localized time difference data.

2. The communication device according to claim 1, wherein the communication code comprises telephone number data, and the communication data comprises country code and area code data.

3. The communication device according to claim 1, wherein the communication device is a cellular phone.

4. The communication device according to claim 1, wherein the communication device is a screen phone.

5. The communication device according to claim 1, wherein the communication device is a personal digital assistant (PDA).

6. The communication device according to claim 1, further comprising a data amendment module for amending the communication data and the localized time difference of the time difference database.

7. A method of obtaining recipient's local time with a communication device, wherein the communication device comprises original time difference data and a time difference database having a reserve of communication data and localized time difference data respectively corresponding to the communication data, the method comprising the steps of:
executing communication according to a communication code with the communication data;
retrieving localized time difference information corresponding to the communication data from the time difference database; and
obtaining a recipient's local time data according to the original time difference data and the corresponding localized time difference data.

8. The method according to claim 7, wherein the communication code comprises telephone number data, and the communication data comprises country code and area code data.

9. The method according to claim 7, wherein the communication device is a cellular phone.

10. The method according to claim 7, wherein the communication device is a screen phone.

11. The method according to claim 7, wherein the communication device is a personal digital assistant (PDA).
